(19) United States
(12) Patent Application Publication
(10) Pub. No.: US 2025/0029189 A1
(43) Pub. Date: Jan. 23, 2025

(54) METHOD AND SYSTEM FOR PEOPLE INTERACTION

(71) Applicant: Just Crossed Corp., Tampa, FL (US)

(72) Inventors: Manny MANZEL, Tampa, FL (US); Conor CRIGHTON, Tampa, FL (US)

(21) Appl. No.: 18/356,868

(22) Filed: Jul. 21, 2023

(51) Int. Cl. G06Q 50/00; G06F 3/04847

(52) U.S. Cl. CPC G06Q 50/01; G06F 3/04847

(57) ABSTRACT

Aspects of the present disclosure relate generally to systems and methods for personal interaction. A method includes receiving a user selected interaction purpose that is selected by a user from among dating, friendship, and business. The method further includes determining a subset of proximate people to the user by filtering a set of people within a proximity radius of the user responsive to the user selected interaction purpose and the user and each person in the subset of people having respective trajectories that cross paths. The method also includes outputting a control signal to initiate a display device of the user device to display an image of the subset of people. The method additionally includes outputting another control signal to initiate a communication device of the user device to enable communication between the user and the subset of people.

### TECHNICAL FIELD

Aspects of the present disclosure relate generally to systems and methods for people interaction.

### BACKGROUND

People cross paths every day and are unaware of any similar interests that they may share that could form the basis of a personal or business connection. Thus, there is a need for a way to enable people who are near each other to be able to know the interests and information of others that may be pertinent to their own interests.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

According to aspects of the present disclosure, a computer-implemented method is provided. The method includes receiving a user selected interaction purpose that is selected by a user from among dating, friendship, and business. The method further includes determining a subset of proximate people to the user by filtering a set of people within a proximity radius of the user responsive to the user selected interaction purpose and the user and each person in the subset of people having respective trajectories that cross paths. The method also includes outputting a control signal to initiate a display device of the user device to display an image of the subset of people. The method additionally includes outputting another control signal to initiate a communication device of the user device to enable communication between the user and the subset of people.

According to further aspects of the present disclosure, a computer program product configured to enable people interaction on a user device is provided. The computer program product includes one or more non-transitory computer-readable media, having instructions stored thereon that when executed by one or more processors cause the one or more processors, individually or in combination, to perform a method. The method includes receiving a user selected interaction purpose that is selected by a user from among dating, friendship, and business. The method further includes determining a subset of proximate people to the user by filtering a set of people within a proximity radius of the user responsive to the user selected interaction purpose and the user and each person in the subset of people having respective trajectories that cross paths. The method also includes outputting a control signal to initiate a display device of the user device to display an image of the subset of people. The method additionally includes outputting another control signal to initiate a communication device of the user device to enable communication between the user and the subset of people.

According to still further aspects of the present invention, a system for people interaction is provided. The system includes a server configured to store profile information for a plurality of users. The system further includes an application executable on a user device. The application is configured to receive a user selected interaction purpose that is selected by a user from among dating, friendship, and business. The application is further configured to determine a subset of proximate people to the user by filtering a set of people within a proximity radius of the user responsive to the user selected interaction purpose and the user and each person in the subset of people having respective trajectories that cross paths. The application is also configured to output a control signal to initiate a display device of the user device to display an image of the subset of people from the profile information. The application is additionally configured to output another control signal to initiate a communication device of the user device to enable communication between the user and the subset of people.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 illustrates an example of a computer environment, in accordance with example aspects of this disclosure.

FIG. 2 illustrates an example environment to which aspects of the present disclosure can be applied, in accordance with an example aspects of this disclosure.

FIGS. 3-7 illustrate an example of a quantum process estimation method for a QIP system, in accordance with example aspects of this disclosure.

FIG. 8 illustrates an initial screen for a user subscription sign up, in accordance with example aspects of the present disclosure.

FIG. 9 illustrates a filter screen for a user to make filtering selections, in accordance with example aspects of the present disclosure.

FIG. 10 illustrates a matches screen showing user matches and user communications, in accordance with example aspects of the present disclosure.

FIG. 11 illustrates search matches screen showing user matches in a matching area 1191 and a search bar 1181, in accordance with example aspects of the present disclosure.

FIG. 12 illustrates a likes screen showing users that have liked the user and user communications, in accordance with example aspects of the present disclosure.

### DETAILED DESCRIPTION

Aspects of the present disclosure are directed to a method and system for people interaction.

In daily life, people may cross paths one or with some frequency. In any case, it would be desirable to be able to interact with people sharing similar interests who have expressed an intention to interact with others for a given purpose. Such user selected interaction purpose may include, for example, business, dating, and friendship.

Aspects of the present invention enable people whose paths cross to see images of each other as well as other user selected information in order to enable the intended purpose to be achieved. Such information may include, for example but is not limited to: a name; an age; a place of residence; a phone number(s); an email address(es); an interest(s); an education facility; an education degree(s); astrological sign; a company name(s); an occupation(s); and a hiring status.

In various aspects, depending on the user selected interaction purpose, different types of information may be shown along with an image of a user.

Other users that are displayed to a user are preselected from a larger group of proximate users within a proximity radius where the proximate users are filtered responsive to the user selected interaction purpose and the user and each person in the subset of people having respective trajectories that cross paths. In this way, only users that the user may be interested in, versus all proximate users, may be determined and shown to the user along with pertinent information. For example, in an aspect, when a business purpose is selected, a current place of employment (company name) may be used to determine a match between two users and such company name may be displayed along with the user image and potentially the user name. Further information may be available depending on the configuration and may also be based on a subscription level when aspects of the present disclosure are implemented as a subscription service. In the same or other aspects, when a business purpose is selected, an industry of business may be selected by a user and used to match users and/or determine likes. In this way, people can view on their user device, such as a smart phone, other people whose trajectories cross with theirs, with such people filtered to include only people with a user selected interaction purpose(s) in common.

In various aspects, a communication channel is enabled between 2 users that match in their user selected interaction purpose(s) and have trajectories whose paths cross. In this way, communication can be achieved between people with similar interests who are near each other at some point, perhaps even on a frequent basis (e.g., commuting), in the manner as described herein.

Aspects of the present disclosure enable liking, un-liking, and/or other functions via sliding up and/or down. In this way, a user may quickly traverse a list of other users.

Aspects of the present disclosure may be performed in an actual physical environment and/or a virtual reality environment. The environments may overlap such that something that happens in one environments affects and/or otherwise also occurs in the second environment (e.g., likes, communications, introductions, recommendations, etc.).

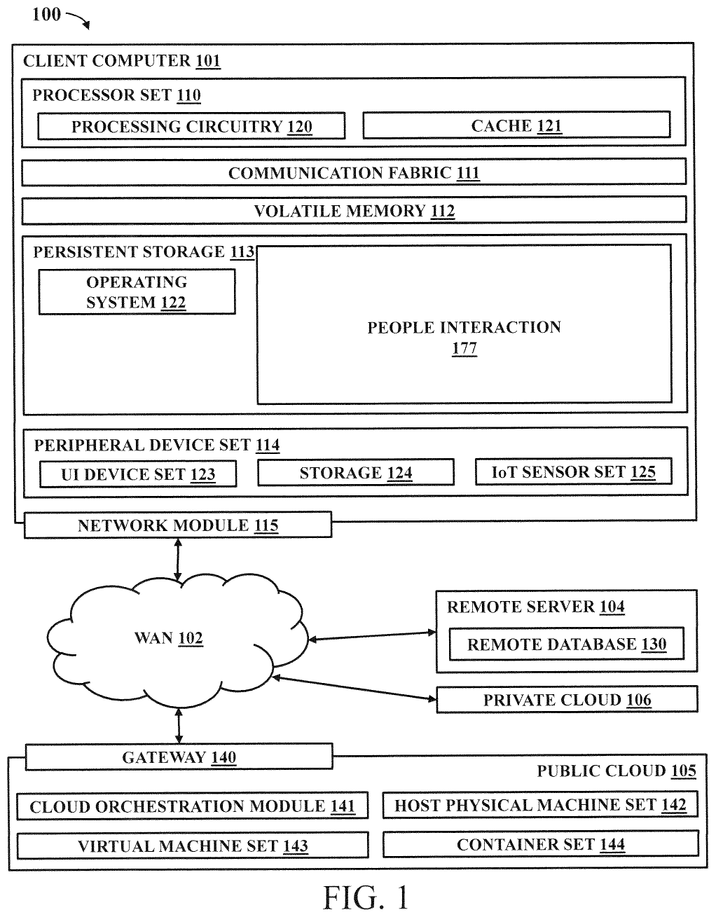

Referring to FIG. 1, an example computing environment 100 is shown, in accordance with an aspect of the present disclosure.

Computing environment 100 includes an example of an environment for the execution of at least some of the computer code 177 involved in performing the inventive methods, such as enabling people interaction. In addition to block (computer code) 177, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 177, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 177 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 177 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, virtual reality goggles, augmented reality goggles, mixed reality goggles, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Public cloud may provide a subscription service for people interaction to a plurality of users such as a user of computer 101. The service can have multiple purposes for people interaction. Such purposes for people interaction can include dating, friendship, and business.

In an aspect, public cloud 105 operates in conjunction with remote server 104 to enable profile information of users to be retrieved and provided to a user such as one using computer 101 and/or another user operating a similar device as computer 101.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

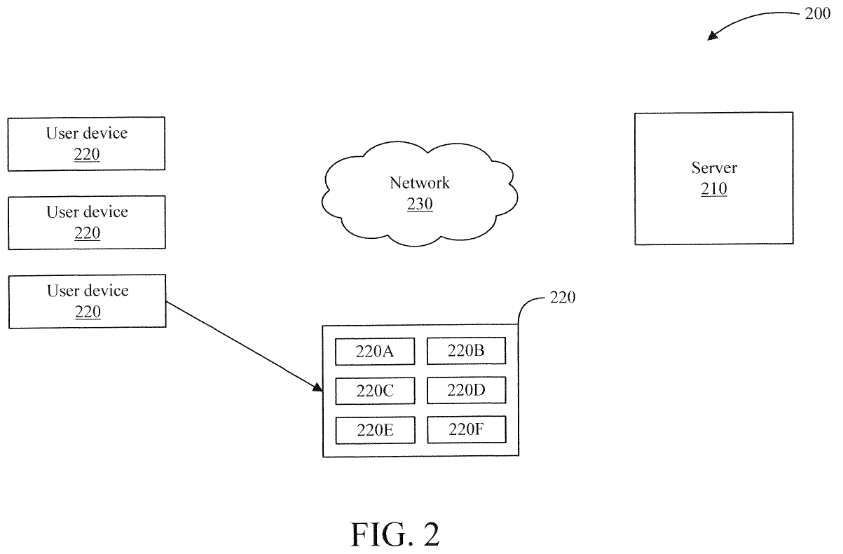

Referring to FIG. 2. an example environment 200 to which aspects of the present disclosure can be applied is shown, in accordance with an examples aspects of the disclosure.

The environment 200 includes a server 210 and a set of user devices 220. The server 210 stores information (e.g., user profiles) for a people interaction application and can provide such information to users such as subscribed users. The set of user devices 220 may include any type of a smart phone, a tablet, a laptop computer, a mobile computer, a desktop computer, a multimedia player, and so forth. In an aspect, server 210 corresponds to remote server 104 and/or public cloud 105 of FIG. 1, and user devices 220 each correspond to an implementation of computer 101 of FIG. 1.

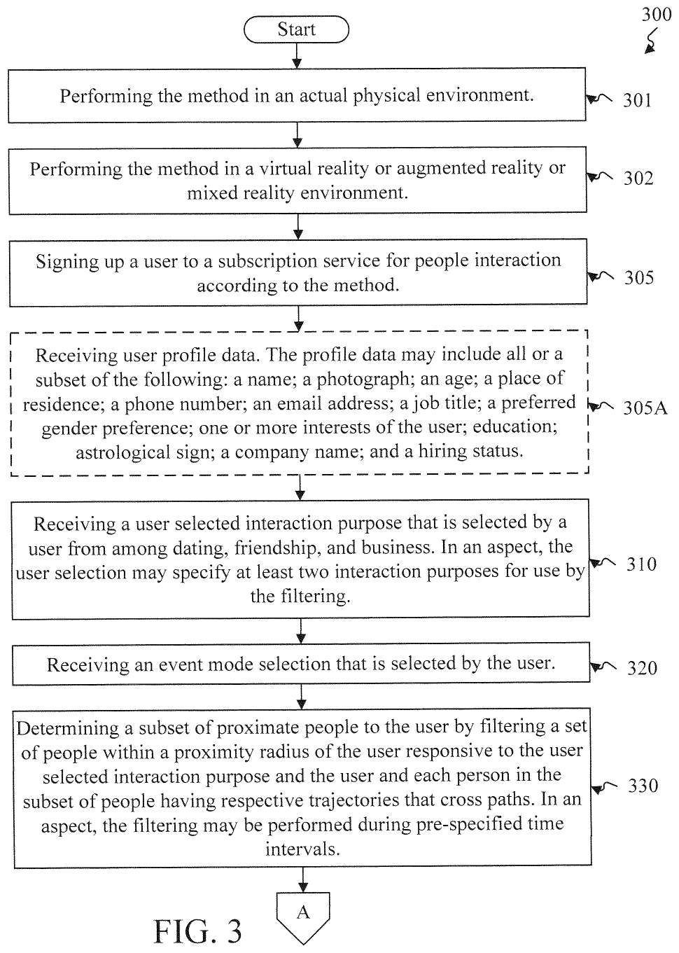

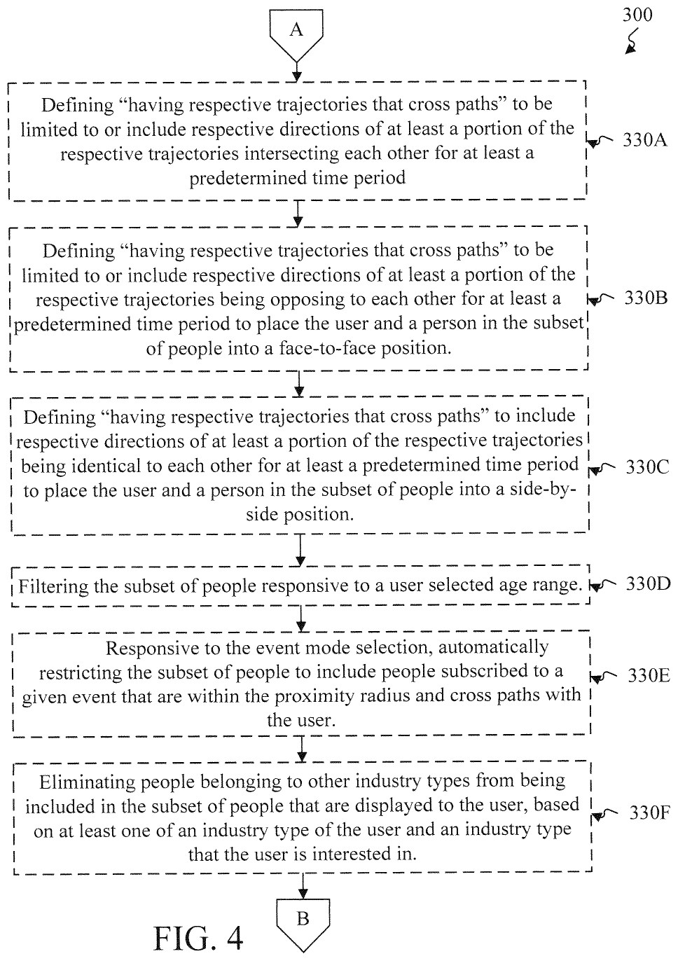

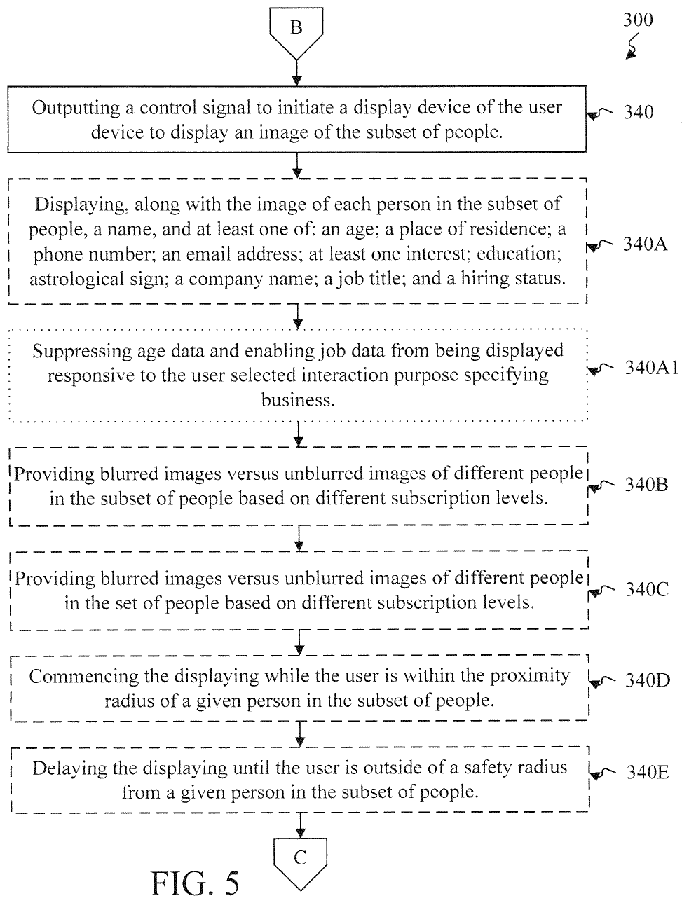

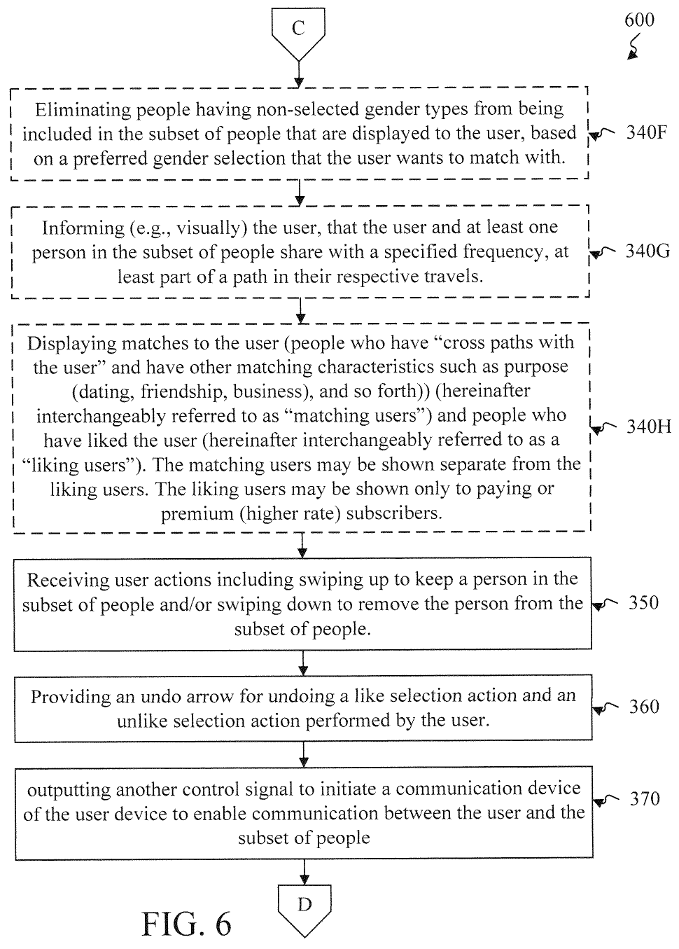

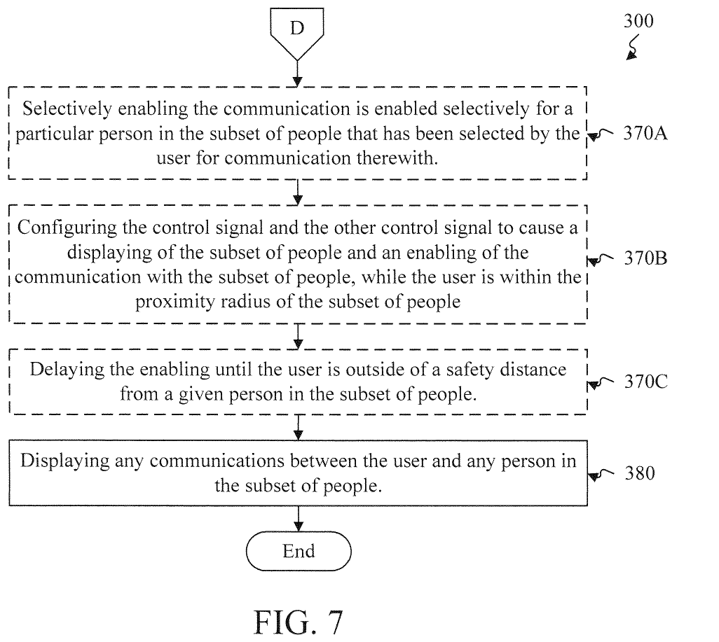

Each device in the set of user devices 220 includes, for example, at least one processor 220A and a at least one memory 220B, a Global Positioning System (GPS) 220C, a communication system 220D, a display 220E, and an input device 220F operatively coupled to the at least one processor 220A. Each memory 220B includes code for a method for people interaction. The method may be method 300 of FIGS. 3-7. The at least one processor 220A may be a single or multicore processor(s), and may include a central processing unit(s) and/or a graphics processing unit(s).

The GPS system 220C typically has a location services setting that allows for authorized applications to track the location of the user. In an aspect, a geofence is implemented with respect to a user's location such that only persons within the geofence can be considered for recommendation to the user depending on a user's application setting as described more fully hereinbelow.

The distance implemented by the geofence is preferably one that coincides with a typical range that a person scans carefully when walking/traveling. For example, while a person is walking in a direction, they may or may not notice people within a given radius, but are more likely to notice people that are on a trajectory that may possibly invade their personal space (e.g., walking in opposing directions towards a common point) or that may overlap with or get close to their personal space (e.g., two people walking side by side). Thus, a short distance for a proximity radius of 1 meter may be used in some embodiments. In other embodiments, such as events, the distance may be increased, including substantially, as it is likely that a person will attempt to scan the room and most of the people at a reasonably sized (couple hundred or so less) business event. In some aspects, the proximity radius used by the present disclosure may be user adjustable. In some aspects, the proximity radius nay be adjusted based on the purpose and/or other setting (time of day, etc.).

The set of user devices 220 communicate with each other and the remote server 210 with one or more networks (collectively denoted “network”) 230.

Referring now to FIGS. 3-7, a people interaction method 300 is shown and described in accordance with various exemplary aspects.

At block 301, the method 300 includes performing the method 300 in an actual physical environment.

At block 302, the method 300 includes performing the method 300 in a virtual reality or augmented reality or mixed reality environment. For example, the method 300 may performed in the Metaverse.

In an aspect, faces of characters in an alternate (non-real/non-actual) environment may be actual face images or character face images may be used. In an aspect, hovering over or clicking or double clicking on a character face shows an actual face image of that user. Likes and matches and other features and aspects of method 300 can occur in the alternate (non-real/non-actual) environments just like in an actual environment. In this way, the user specified interaction purposes can be achieved in either or both of an actual physical environment and an alternate environment(s). In an aspect, liking another user's character in an alternate environment may be analogous to, and trigger, a liking of the other user in an actual physical environment. These and other interactions between the two or more environments may be implemented in accordance with the teachings of the present disclosure.

The environments may overlap such that something that happens in one environments affects and/or otherwise also occurs in the second and/or third and so forth environment (e.g., likes, communications, introductions, recommendations, etc.).

It is to be appreciated that blocks 301 and 302 are not mutually exclusive and may be concurrently performed in an implementation of method 300.

At block 305, the method 300 includes signing up a user to a subscription service for people interaction according to the method 300.

In an aspect, block 305 may include block 305A.

At block 305A, the method 300 includes receiving user profile data. The profile data may include all or a subset of the following: a name; a photograph(s); an age; a place of residence; a phone number(s); an email address(es); an occupation(s) of the user; a preferred gender preference (that the user identifies with (optionally including pronouns) and/or the user would like to meet/interact with); one or more interests of the user (including in text, image, multimedia, and Uniform Resource Locator (URL) form); an education facility or facilities; an education degree(s); astrological sign; a company name of a company at which the user works and/or previously worked and a hiring status of the company at which the user works.

At block 310, the method 300 includes receiving a user selected interaction purpose that is selected by a user from among dating, friendship, and business. In an aspect, the user selection may specify at least two interaction purposes for use by the filtering.

At block 320, receiving an event mode selection that is selected by the user.

At block 330, the method 300 includes determining a subset of proximate people to the user by filtering a set of people within a proximity radius of the user responsive to the user selected interaction purpose and the user and each person in the subset of people having respective trajectories that cross paths. In an aspect, the filtering may be performed during pre-specified time intervals. In an aspect, the filtering is performed by the user device. In an aspect, the filtering is performed by the server storing user profiles.

In an aspect, method 300 may include one or more of blocks 330A through 330F.

At block 330A, the method 300 includes defining “having respective trajectories that cross paths” to be limited to or include respective directions of at least a portion of the respective trajectories intersecting each other for at least a predetermined time period.

At block 330B, the method 300 includes defining “having respective trajectories that cross paths” to be limited to or include respective directions of at least a portion of the respective trajectories being opposing to each other for at least a predetermined time period to place the user and a person in the subset of people into a face-to-face position.

At block 330C, the method 300 includes defining “having respective trajectories that cross paths” to include respective directions of at least a portion of the respective trajectories being identical to each other for at least a predetermined time period to place the user and a person in the subset of people into a side-by-side position.

At block 330D, the method 300 includes filtering the subset of people responsive to a user selected age range.

At block 330E, the method 300 includes, responsive to the event mode selection, automatically restricting the subset of people to include people subscribed to a given event that are within the proximity radius and cross paths with the user.

At block 330F, the method 300 includes eliminating people belonging to other industry types from being included in the subset of people that are displayed to the user, based on at least one of an industry type of the user and an industry type that the user is interested in. The industry type of the user and the industry type(s) that the user is interested in may be provided at block 305 as profile information.

At block 340, the method 300 includes displaying an image of each person in the subset of people.

In an aspect, method 300 may include one or more of blocks 340A through 340H.

At block 340A, the method 300 includes displaying, along with the image of each person in the subset of people, a name, and at least one of: an age; a place of residence; a phone number; an email address; at least one interest; an education facility; an education degree; astrological sign; a company name; an occupation; and a hiring status. The image may be suppressed for other than premium subscriptions.

At block 340A1, the method 300 includes suppressing age data and enabling job data from being displayed responsive to the user selected interaction purpose specifying business.

At block 340B, the method 300 includes providing blurred images versus unblurred images of different people in the subset of people based on different subscription levels.

At block 340C, the method 300 includes providing blurred images versus unblurred images of different people in the set of people based on different subscription levels. For examples, “likes” (people who like the user) may be blurred for non-premium users (subscribers).

At block 340D, the method 300 includes commencing the displaying while the user is within the proximity radius of a given person in the subset of people.

At block 340E, the method 300 includes delaying the displaying until the user is outside of a safety radius from a given person in the subset of people. In an aspect, the safety distance is greater than the proximity radius. In other aspects, the proximity radius and the safety radius are equal or the safety radius is less than the proximity radius.

At block 340F, the method 300 includes eliminating people having non-selected gender types from being included in the subset of people that are displayed to the user, based on a preferred gender selection that the user wants to match with. The preferred gender selection may be provided at block 305 as profile information.

At block 340G, the method 300 includes informing the user, that the user and at least one person in the subset of people share with a specified frequency, at least part of a path in their respective travels. While this embodiment presupposed the information being provided visually, in other aspects, the information can be provided by the speaker.

At block 340H, the method 300 includes displaying matches to the user (people who have cross paths with the user and have other matching characteristics such as purpose (dating, friendship, business), and so forth)) (hereinafter interchangeably referred to as “matching users”) and people who have liked the user (hereinafter interchangeably referred to as a “liking users”). In an aspect, the matching users may be shown separate from the liking users. In an aspect, the liking users may be shown only to paying or premium (higher rate) subscribers. A matching user may have a purpose, a job, an interest, and so forth in common.

At block 350, the method 300 includes receiving user actions including swiping up to keep a person in the subset of people and/or swiping down to remove the person from the subset of people.

At block 360, the method 300 includes providing an undo arrow for undoing a like selection action and an unlike selection action performed by the user.

At block 370, the method 300 includes outputting another control signal to initiate a communication device of the user device to enable communication between the user and the subset of people.

In an aspect, the method 300 may include one or more of blocks 370A through 370C.

At block 370A, the method 300 includes selectively enabling the communication is enabled selectively for a particular person in the subset of people that has been selected by the user for communication therewith.

At block 370B, the method 300 includes configuring the control signal and the other control signal to cause a displaying of the subset of people and an enabling of the communication with the subset of people, while the user is within the proximity radius of the subset of people.

At block 370C, the method 300 includes delaying the enabling until the user is outside of a safety distance from a given person in the subset of people. In an aspect, the safety distance is greater than the proximity radius. In other aspects, the proximity radius and the safety radius are equal or the safety radius is less than the proximity radius.

At block 380, the method 300 includes displaying any communications between the user and any person in the subset of people. In an aspect, the communications may be displayed along with an image of the person(s) (in the subset of people) communicating with the user.

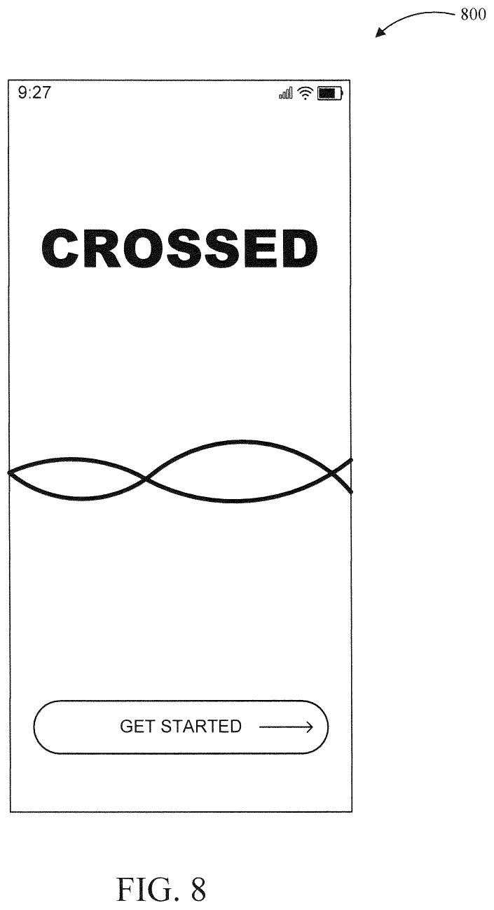

Referring to FIGS. 8-12, various display screens are shown and described. While various types of user actuation devices such as sliders, buttons, and so forth are described, aspects of the present disclosure are not limited to the same and other types of actuation devices and symbols and mechanisms may also be used.

Referring to FIG. 8, an initial screen 800 for a user subscription sign up is shown, in accordance with example aspects of the present disclosure.

The initial screen 800 is followed by screens (now shown) prompting the user for their personal data including, for example, but not limited to, a phone number, an email address, a name, an image(s), an age or date of birth, a place of residence, an occupation, a preferred gender preference, interests, a company name, and a hiring status. If the user does not have an image ready, the user device may be used to capture an image of the user. The image can be of the user and can also include images of items of interest to the user.

In an aspect, two-factor authentication is used once the telephone number and email address are provided to ensure the identity of the user, preferably before the application continues processing user input data.

In an aspect, the user is asked to turn on location services on their device so that their location can be tracked by the people interaction application.

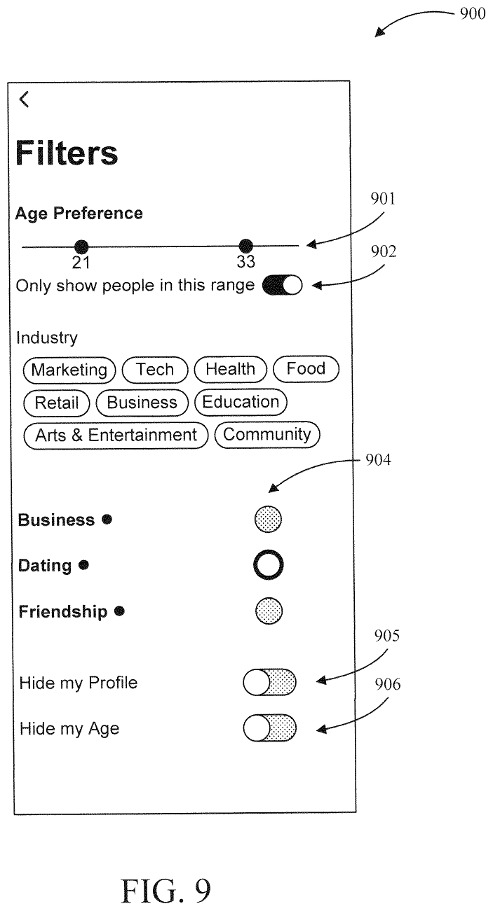

Referring to FIG. 9, a filter screen 900 for a user to make filtering selections is shown, in accordance with example aspects of the present disclosure.

The filtering screen 900 includes a slider 901 for marking an age range that may be used to filter results depending on a position of another slider 902. In an aspect, the age range may be applied to filter the results for only selective ones of the purposes described below such as, for example, dating but possibly not business or friendship. The settings are user determinable.

The filtering screen 900 further includes a set of buttons 903 for selecting an industry from a set of industries and may include an option for adding an unlisted industry. Example industries includes marketing, technology (tech), health, food, retail, business, education, arts & entertainment, and community. The preceding listing is merely illustrative and not exhaustive.

The filtering screen 900 also includes a set of buttons 904 for enabling one or more purposes such as, for example, dating, friendship, and business.

The filtering screen 900 additionally includes a slider 905 for hiding the user's profile information and another slider 906 for hiding the user's age.

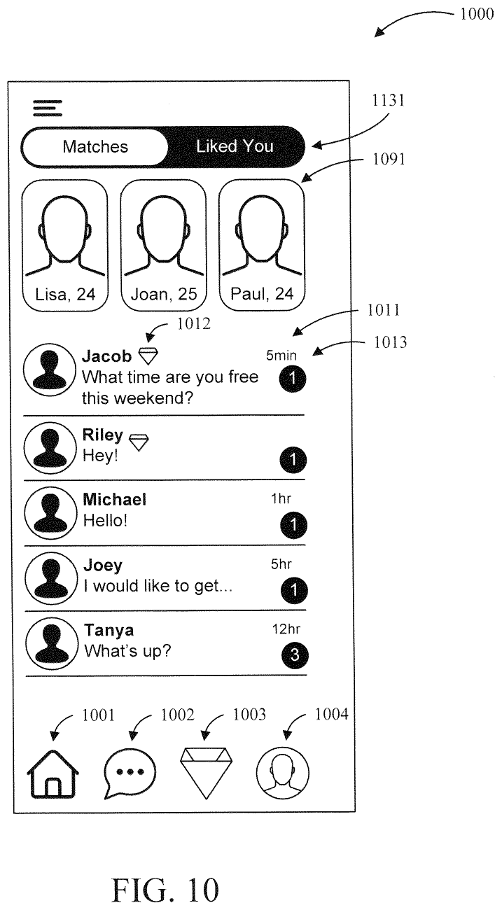

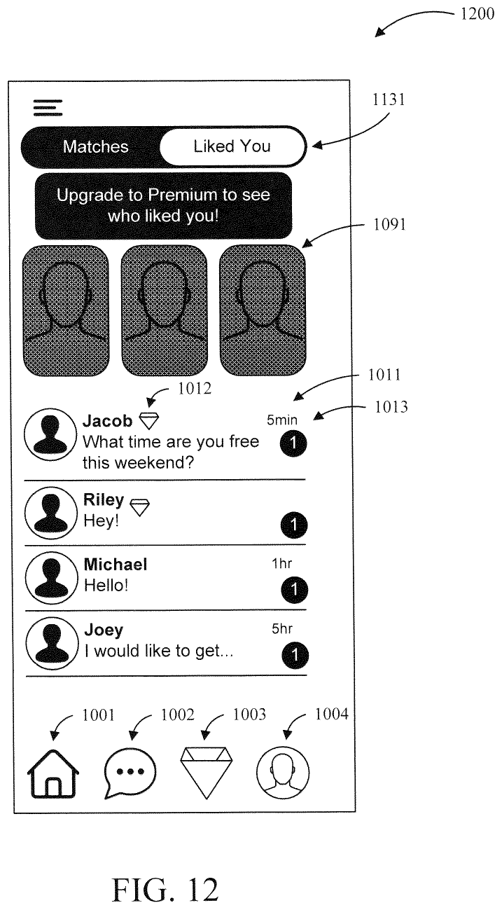

Referring to FIGS. 10 and 12, a matches screen 1000 showing user matches and user communications is shown, in accordance with example aspects of the present disclosure. A match exists when a person and another person are within a proximity radius and share at least one common purpose and possible other data depending on user settings. For example, age and other data may also be used to determine matches. A like exists when there is a match, and the user likes matching person.

The matches screen 1000 includes a matches area 1091 for showing matches to the user. The matches screen 1000 includes a messaging area 1011 for showing user communications and from whom. The messaging area 1011 further includes a diamond indication 1012 for indicating that a particular other user(s) liked the user, and a time indication 1013 of when the last communication was sent by either the user or the particular other user(s).

The matches screen 1000 further includes a home button 1001, a chat button 1002 for initiating a chat with a particular other user (e.g., a selected other user, as selected in the images section 1121), a diamond button 1003 for liking someone, and a user profile button 1004.

Transitions back and forth from matches (match screen 1000) to likes (likes screen 1200 of FIG. 12) may be made by a slider 1131.

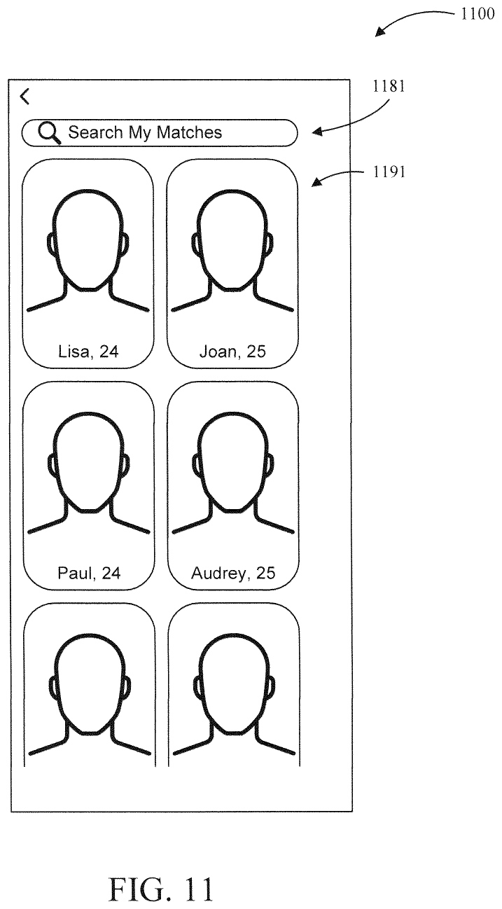

Referring to FIG. 11, a search matches screen 1100 showing user matches in a matching area 1191 and a search bar 1181 is shown, in accordance with example aspects of the present disclosure.

The search matches screen 1100 allows a user to search matches to the user. Images of matches may be shown with one or more pieces of profile information, such as name, age, industry, and so forth as described herein.

Referring to FIG. 12, a likes screen 1200 showing users that have liked the user and user communications is shown, in accordance with example aspects of the present disclosure.

As shown in the aspect of FIG. 12, images of people liking the user are blurred for non-premium subscriptions in an area 1201.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A computer-implemented method for people interaction performed on a user device, the method comprising:
receiving a user selected interaction purpose that is selected by a user from among dating, friendship, and business;
determining a subset of proximate people to the user by filtering a set of people within a proximity radius of the user responsive to the user selected interaction purpose and the user and each person in the subset of people having respective trajectories that cross paths;
outputting a control signal to initiate a display device of the user device to display an image of the subset of people; and
outputting another control signal to initiate a communication device of the user device to enable communication between the user and the subset of people.

2. The computer-implemented method in accordance with claim 1, further comprising outputting a control signal to initiate the display device to display, along with the image of the subset of people, a name, and at least one of: an age; a place of residence; a phone number; an email address; an interest; an education facility; an education degree; astrological sign; a company name; an occupation; and a hiring status.

3. The computer-implemented method in accordance with claim 2, further comprising suppressing age data and enabling job data is enabled from being displayed responsive to the user selected interaction purpose specifying business.

4. The computer-implemented method in accordance with claim 1, wherein the filtering comprising filtering the subset of people responsive to a user selected age range.

5. The computer-implemented method in accordance with claim 1, wherein the method is performed as a subscription service, and wherein different subscription levels provide blurred images versus unblurred images of different people in the subset of people.

6. The computer-implemented method in accordance with claim 1, wherein the method is performed as a subscription service, and wherein different subscription levels provide blurred images versus unblurred images of different people in the set of people.

7. The computer-implemented method in accordance with claim 1, wherein the communication is enabled selectively for a particular person in the subset of people that has been selected by the user for communication therewith.

8. The computer-implemented method in accordance with claim 1, wherein the control signal and the other control signal are configured to cause a displaying of the subset of people and an enabling of the communication with the subset of people, while the user is within the proximity radius of the subset of people.

9. The computer-implemented method in accordance with claim 8, wherein the displaying and the enabling are delayed until the user is outside of a safety radius from a given person in the subset of people.

10. The computer-implemented method in accordance with claim 9, wherein the safety radius is greater than the proximity radius.

11. The computer-implemented method in accordance with claim 1, wherein the method is performed in an actual physical environment.

12. The computer-implemented method in accordance with claim 1, wherein the method is performed in any of a virtual reality environment, an augmented reality environment, and a mixed reality environment.

13. The computer-implemented method in accordance with claim 1, wherein the user selection specifies at least two interaction purposes for use by the filtering.

14. The computer-implemented method in accordance with claim 1, further comprising receiving an event mode selection that is selected by the user, the event mode selection automatically restricting the subset of people to include people subscribed to a given event that are within the proximity radius and cross paths with the user.

15. The computer-implemented method in accordance with claim 1, further comprising eliminating people having non-selected gender types from being included in the subset of people, based on a preferred gender selection that the user wants to match with.

16. The computer-implemented method in accordance with claim 1, further comprising eliminating people belonging to other industry types from being included in the subset of people, based on at least one of an industry type of the user and an industry type that the user is interested in.

17. The computer-implemented method in accordance with claim 1, further comprising informing the user, that the user and at least one person in the subset of people share with a specified frequency, at least part of a path in their respective travels.

18. The computer-implemented method in accordance with claim 1, further comprising receiving user actions comprising swiping up to keep a person in the subset of people, and swiping down to remove the person from the subset of people.

19. The computer-implemented method in accordance with claim 1, further comprising providing a user interface having an undo arrow for undoing a like selection action and an unlike selection action performed by the user.

20. The computer-implemented method in accordance with claim 1, wherein having respective trajectories that cross paths comprises respective directions of at least a portion of the respective trajectories intersecting each other for at least a predetermined time period.

21. The computer-implemented method in accordance with claim 1, wherein having respective trajectories that cross paths comprises respective directions of at least a portion of the respective trajectories being opposing to each other for at least a predetermined time period to place the user and a person in the subset of people into a face-to-face position.

22. The computer-implemented method in accordance with claim 20, wherein having respective trajectories that cross paths further comprises respective directions of at least a portion of the respective trajectories being identical to each other for at least a predetermined time period to place the user and a person in the subset of people into a side-by-side position.

23. The computer-implemented method in accordance with claim 1, wherein the filtering is performed during pre-specified time intervals.

24. The computer-implemented method in accordance with claim 1, wherein the control signal causes a displaying of (i) matches to the user and (ii) people who have liked the user.

25. The computer-implemented method in accordance with claim 24, wherein people who have liked the user are blurred for non subscribing or non-premium users.

26. The computer-implemented method in accordance with claim 1, wherein the proximity radius is used adjustable.

27. The computer-implemented method in accordance with claim 1, wherein the computer-implemented method is performed by an application running on the user device.

28. A computer program product configured to enable people interaction on a user device, the computer program product comprising one or more non-transitory computer-readable media, having instructions stored thereon that when executed by one or more processors cause the one or more processors, individually or in combination, to perform a method comprising:
receiving a user selected interaction purpose that is selected by a user from among dating, friendship, and business;
determining a subset of proximate people to the user by filtering a set of people within a proximity radius of the user responsive to the user selected interaction purpose and the user and each person in the subset of people having respective trajectories that cross paths;
outputting a control signal to initiate a display device of the user device to display an image of the subset of people; and
outputting another control signal to initiate a communication device of the user device to enable communication between the user and the subset of people.

29. A system for people interaction, comprising:
a server configured to store profile information for a plurality of users; and
an application executable on a user device and configured to:
receive a user selected interaction purpose that is selected by a user from among dating, friendship, and business;
determine a subset of proximate people to the user by filtering a set of people within a proximity radius of the user responsive to the user selected interaction purpose and the user and each person in the subset of people having respective trajectories that cross paths;
output a control signal to initiate a display device of the user device to display an image of the subset of people from the profile information; and
output another control signal to initiate a communication device of the user device to enable communication between the user and the subset of people.
